(19) United States
(12) Patent Application Publication
(10) Pub. No.: US 2014/0298174 A1
(43) Pub. Date: Oct. 2, 2014

(54) VIDEO-KARAOKE SYSTEM

(71) Applicant: Artashes Valeryevich IKONOMOV, (US)

(72) Inventor: Artashes Valeryevich Ikonomov, Moscow (RU)

(21) Appl. No.: 14/354,096

(22) PCT Filed: May 8, 2013
(86) PCT No.: PCT/RU2013/000386

§ 371 Date: Apr. 24, 2014

(30) Foreign Application Priority Data
May 28, 2012 (RU) 2012121853

(51) Int. Cl. G06F 3/0484; G06F 3/0481

(52) U.S. Cl. CPC G06F 3/0484; G06F 3/0481
USPC 715/719

(57) ABSTRACT

Devices and musical systems with video-imaging, such as video-karaoke systems which can be used by a large number of users simultaneously comprise a unified network such as the Internet, or another form of data-exchange network connected to at least one server and to a plurality of client user devices. Each client user device comprises means of inputting, processing, and outputting an audio stream connected to a microphone and to playback devices, means of processing and outputting a video stream connected to a display, a control unit in the form of a user interface. At least one server comprises an audio-data selection module, a video-data selection module, a memory device for storing audio and video data, a unit for the selection and design of a virtual image of the user and a unit for the selection and design of an interior of a virtual cafe visualizing karaoke system for each user.

The utility model relates to devices and musical systems with video-imaging, and more specifically to video-karaoke systems comprising means of inputting, processing, and outputting an audio stream connected to a microphone and to playback devices, means of processing and outputting a video stream connected to a display, a control unit, an audio data selection module, a video data selection module, and a memory device for storing audio and video data, which utility model can be used in various social network entertainment setups by a large number of users simultaneously.

It is known a video-karaoke system comprising means of audio and video signal search, means of audio and video signal processing, means of audio and video signal transmission, a control unit with a switching matrix, means of data storage and output on a display, see patent application n°2000112271, published in 2002.

The known solution has a drawback, namely, the fact that there is no option for simultaneous remote communication of a multitude of the video-karaoke system users. Another drawback of said solution is the lack of option to select a virtual user image and a virtual cafe interior design visualizing the video-karaoke system for each user.

Another known example of prior art is a video-karaoke system comprising means of inputting, processing, and outputting an audio stream connected to a microphone and to playback devices, means of processing and outputting a video stream connected to a display, a control unit, an audio data selection module, a video data selection module, and a memory device for storing audio and video data (see Patent of Russian Federation n°2178922, published in 2002). The described device comprises an audio signal control processor, a video signal control processor and a voice signal control processor as means of inputting, processing and outputting an audio and a video stream. Read-only memory devices for storage of music score and background images and cartridges containing music score and background images are used as the memory device for storing audio and video data. The control unit is realized as a mixer and a switching matrix.

The above device is used herein as a prototype of the claimed utility model.

The prototype has a drawback, namely no option for simultaneous remote communication of a multitude of the video-karaoke system users. Another drawback of said prototype is the lack of option to select a virtual user image and a virtual cafe interior design visualizing the video-karaoke system for each user. Yet another drawback of said prototype is the lack of an option of quality rating of a user's music performance by other users. All of the above limit the functionality of the known system.

The present utility model relies on this novel observation with the primary aim to offer a video-karaoke system that could at least mitigate one of the above drawbacks, namely by solving a technical issue of functionality enhancement.

For the above purpose, the video-karaoke system comprises a unified network such as the Internet, or another form of data-exchange network connected to at least one server and to a plurality of client user devices, said client user device comprises means of inputting, processing, and outputting an audio stream connected to a microphone and to playback devices, means of processing and outputting a video stream connected to a display, a control unit in the form of a user interface, for this purpose at least one server comprises an audio-data selection module, a video-data selection module, a memory device for storing audio and video data, a unit for the selection and design of a virtual image of the user and a unit for the selection and so design of an interior of a virtual cafe visualizing the video-karaoke system for each user.

The above makes it possible for a multitude of video-karaoke system users to communicate remotely at the same time. Besides, each user has an option to select a virtual image or a virtual cafe interior design visualizing the video-karaoke system.

A version of the utility model includes the unit for design and selection of a virtual cafe interior visualizing the video-karaoke system for each user, which comprises additionally a 3D stage building module.

This option makes it possible to use 3D imaging to enhance the user's virtual presence in the cafe that visualizes the video-karaoke system for each user.

A version of the utility model includes at least one client device having a video stream input system to upload said video stream onto a video data server-side storage device through the unified network.

This option makes it possible for users to upload video data to accompany their performance onto the server. For example, a user can film his/her own performance and upload the resulting video onto the server.

Another version of the utility model includes a server having additionally a unit for rating of a user performance by other users involved in a video-karaoke session.

This option makes it possible for all users of the video-karaoke system to rate a quality of each user's performance and notify him his score for his performance.

Another version of the utility model includes the unit for the selection and design of an interior of a virtual cafe comprising in its design a “Cafe4tune” logo.

This option makes it possible for a user to identify the virtual cafe where the video-karaoke session takes place, and serves to promote and advertise the Cafe4tune virtual cafe.

The combination of the essential features of the claimed utility model is not known from the prior art, therefore the utility model possesses the required feature of novelty.

Other distinguishing features and advantages of the utility model are readily apparent from the description below, which includes but is not limited to the following features, with reference to the attached FIGURE:

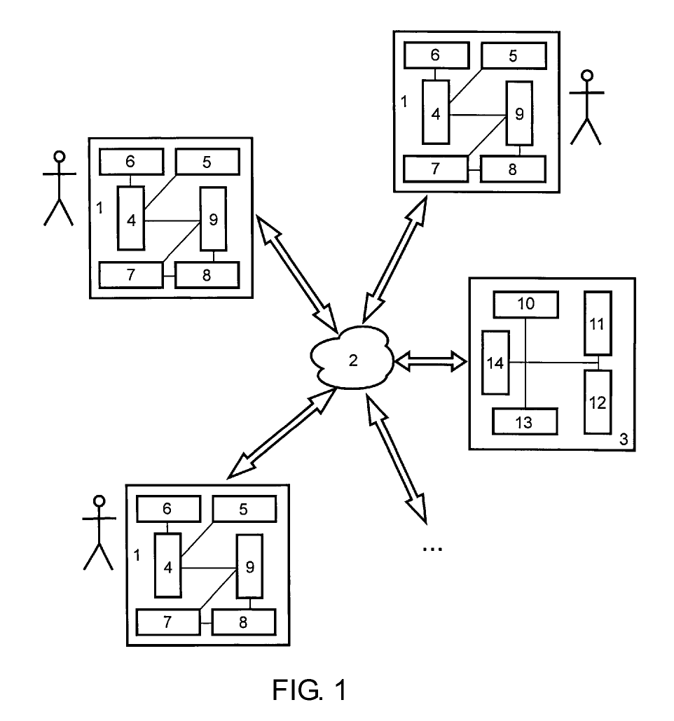

FIG. 1 schematically shows a block diagram of a video-karaoke system.

A video-karaoke system comprises user client devices 1 connected within a unified network 2 such as the Internet or another data-exchange network connected to at least one server 3.

Each user client device comprises means 4 of inputting, processing and outputting an audio stream, connected to a microphone 5 and to playback devices 6, means 7 of processing and outputting a video stream connected to a display 8, and a control unit 9 in the form of a user interface.

The server 3 comprises an audio-data selection module 10, a video-data selection module 11, a memory device 12 for storing audio and video data, a unit 13 for the selection and design of a virtual image of the user, and a unit 14 for the selection and design of an interior of a virtual cafe visualizing the video-karaoke system for each user.

The unit 14 for the selection and design of an interior of a virtual cafe visualizing the video-karaoke system for each user comprises additionally a 3D stage building module, said module is not shown on the FIG. 1.

In general, any variety of computing platforms that can be connected to a network such as a unified network and can interact with applications can be a client device. Standard examples of some such client devices include but are not limited to desktop and laptop personal computers, smart cellular phones, lightweight clients, workstations, “non-intelligent” terminals connected to the application server and various combinations and configurations of the same that are self-evident for those skilled in the art, i.e. these include both physical devices that ensure interaction as part of communication and virtual devices based on programmable computers and having program interface to enable such communication.

The unified network comprises a multitude of topologies, configurations and arrangements of the internetworking components built so as to connect corporate, global and local computer networks. Such network includes but is not limited to traditional wired and wireless, satellite, optical and equivalent networking technology that are self-evident for those skilled in the art.

The unit 13 for the selection and design of a virtual image of the user provides a selection of 2D and 3D images.

The server 3 can comprise additional modules:
a music score selection module;
a video background selection module;
a music and singing mixing module;
a mixed audio track saving module;
a mixed audio track broadcasting module;
an audio and video track mixing module;
a mixed audio and video track saving module;
a video-karaoke stream broadcasting module.

The video-karaoke system functions as follows.

Users connect client devices 1 to the network 2 and link to the server 3. Then they access the social network which is the environment for this utility model, e.g. Cafe4tune. The users select their virtual image and a design of an interior of the cafe visualizing the video-karaoke system for each user. The 3D stage building module serves to create a 3D user experience illusion in the virtual cafe visualizing the video-karaoke system for each user.

The video-karaoke is generated in one of two modes: an autonomous video-karaoke generation mode or an online performance mode. The modes are selected via the user interface 9.

The difference between these modes is that the video-karaoke session in the autonomous mode is not broadcast through the network, can be memorized as a user resource, published for later viewing/listening or broadcast through the network after processing.

The online performance mode implies that the performance can be broadcast at the same time through the network following selection of the music score and (optionally) the video background.

Both modes involve selection of a music score in the music score selection module. The music score can be selected from the server-based tunes or from an own music score file. The assigned own file is uploaded and stored on the server 3.

If it is necessary to create a video-karaoke with a video background, the latter can be selected in the video background selection module. The video background can be selected from the server 3 based video files, or a video file can be assigned, or the online video broadcast can be streamed online from the user camera.

A 2D or 3D user image can be selected to represent the user in the network by means of the unit 13 for the selection and design of a virtual image of the user.

The selected user image is shown during the performance of the video-karaoke on the screens of the users who are currently viewing/listening to the video-karaoke session.

The user selects a pre-generated 3D performer image from the list of images by means of the unit 13 for the selection and design of a virtual image of the user. If none of the images matches the user needs, the user can access the image generation mode, upload the pre-generated image to the list of images and select the resulting image.

A 2D image is selected from the user-uploaded or assigned file with 2D static image files.

The system interface has two windows to play the video-karaoke session: a video track streaming window and an audio track streaming window. Each of the windows has a playback start, stop and pause buttons.

The audio streaming window has additional volume up and down buttons.

The video streaming window has additional full screen and minimize buttons to adjust the video streaming window size.

The system has a separate start, pause and stop button cluster to control the video-karaoke session in general, i.e. to control simultaneous playback of the music score, the video background and the user performance stream.

Record/Do Not Record tools are provided if the user needs to record or discard the video-karaoke session.

The video-karaoke session is recorded on the server 3 and is later utilized as the user resource.

The recorded video-karaoke sessions can be reused multiple times for private listening or for publishing so that they could be later viewed/listened to by other users.

The user selects the virtual cafe as a virtual location of the video-karaoke performance or the online streaming.

Each cafe is represented as a 3D model comprising an image of a stage as its structural element. The user-selected 3D performer image is placed in the center of the stage. The 3D image can be animated on stage by motion patterns and facial expressions.

If a 2D image is selected, said 2D image is also placed in the center of the stage. All users of the virtual cafe that are currently in said cafe become at the same time the participants of the video-karaoke viewing/listening session.

The participants of the listening/viewing sessions (guests) are placed in the virtual cafe in accordance with the general rules that are applicable to the same.

The users in the virtual cafe are notified of the video-karaoke playback as soon as the dedicated button is pressed. The guests of the virtual cafe also see on their screens a video-karaoke playback window with control buttons, i.e. video-karaoke playback stop button, volume up and down buttons, a full screen button and a minimize button.

As soon as the video-karaoke playback is finished, the video-karaoke rating button appears. The listener rates the video-karaoke accordingly, said rating then stored on the server 3. Following server-side integration of all user ratings applause is sounded. For this purpose, the server 3 initiates a preset waiting session, after that all ratings are summed up and, in view of their sum, an applause intensity is determined. The applause is integrated in the audio that is streamed to all cafe guests.

The above description of exemplary versions of the utility model serves to illustrate and characterize said model, but is not meant to be taken as an exhaustive description or a limitation of the utility models by the exact versions described. The above description allows for modifications and alterations that can also be derived from the use of the utility model.

Persons skilled in the art also understand that the utility model components as described above may be incorporated in a multitude of software varieties, built-in applications and hardware in their respective versions as shown in the diagram. Any actual program code or specialized hardware control used for materialization of the objects in accordance with the basic principles of said utility model do not serve to limit the utility model. Therefore, the utility model components and their functionality have been described herein without reference to a specific program code, as it is evident that a person skilled in the art is capable of developing software and controlling hardware to implement such components based on the description as given herein.

A video-karaoke system in the environment of the Cafe4tune social network has been made in accordance with the utility model claimed. Trial runs of said video-karaoke-system demonstrated that the latter:
enables a multitude of remote users to communicate within the video-karaoke systems at the same time;
involves both 2D and 3D virtual user images in the video-karaoke systems, said images can be selected from the database or uploaded by the user;
involves a selection of the virtual cafe interior design from the database to visualize the video-karaoke system for each user;
enables other users in the video-karaoke session to rate the performance.

Therefore, the solution is deemed to achieve the result claimed, i.e. it serves to extend the functionality of the video-karaoke system.

An additional technical benefit of the utility model claimed is an enhanced user experience in the Cafe4tune virtual cafe as well as promotion and advertising of the Cafe4tune virtual cafe.

1. Video-karaoke system comprising:
means of inputting, processing, and outputting an audio stream connected to a microphone and to playback devices,
means of processing and outputting a video stream connected to a display,
a control unit,
an audio data selection module,
a video data selection module,
a memory device for storing audio and video data,
wherein the video-karaoke system comprises a unified data-exchange network connected to at least one server and to a plurality of client user devices,
wherein said client user device comprises:
means of inputting, processing, and outputting an audio stream connected to a microphone and to playback devices,
means of processing and outputting a video stream connected to a display,
a control unit in the form of a user interface,
wherein at least one server comprises:
an audio-data selection module,
a video-data selection module,
a memory device for storing audio and video data,
a unit for the selection and design of a virtual image of the user, and
a unit for the selection and design of an interior of a virtual cafe visualizing the video-karaoke system for each user.

2. Video-karaoke system according to claim 1, wherein the unit for the selection and design of an interior of a virtual cafe visualizing the video-karaoke system for each user comprises additionally a 3D stage building module.

3. Video-karaoke system according to claim 1, wherein at least one client device has a video stream input system to upload said video stream onto a video data server-side storage device through the unified network.

4. Video-karaoke system according to claim 1, wherein the server has additionally a unit for rating of a user performance by other users involved in a video-karaoke session.

5. Video-karaoke system according to claim 1, wherein, in addition, at least one server comprises:
a music score selection module;
a video background selection module;
a music and singing mixing module;
a mixed audio track saving module;
a mixed audio track broadcasting module;
an audio and video track mixing module;
a mixed audio and video track saving module;
a video-karaoke stream broadcasting module.

6. Video-karaoke system according to claim 2, wherein the 3D stage building module is adapted to create a 3D user experience illusion in the virtual cafe visualizing the video-karaoke system for each user.

7. Video-karaoke system according to claim 5, wherein it is adapted to be generated in one of two modes selected via the user interface from following modes: (a) an autonomous video-karaoke generation mode; (b) an online performance mode.

8. Video-karaoke system according to claim 7, wherein both modes are adapted to involve selection of a music score in the music score selection module.

9. Video-karaoke system according to claim 5, wherein it is adapted to be generated with a video background selected via the video background selection module from one of following sources: (a) from video files based on at least one server; (b) from an assigned video file; (c) from an online video broadcast streamed online from a user camera.

10. Video-karaoke system according to claim 2, wherein the unit for the selection and design of a virtual image of the user is adapted to represent the user with the help of a 3D user image, and wherein the 3D user image is placed in the center of an image with a 3D stage realized with the help of the 3D stage building module.

11. Video-karaoke system according to claim 10, wherein the 3D user image animated by motion patterns and facial expressions.

12. Video-karaoke system according to claim 4, wherein the server is adapted to initiate a preset waiting session, wherein all ratings are summed up at the end of the preset waiting session, and wherein the server is adapted to determine an applause intensity as a function of all ratings summed up.

13. Video-karaoke system according to claim 2, wherein the unit for the selection and design of a virtual image of the user is adapted to represent the user with the help of a 2D static user image, and wherein the 2D static user image is placed in the center of an image with a 3D stage realized with the help of the 3D stage building module.

14. Video-karaoke system according to claim 1, wherein its user interface has a video track streaming window and an audio track streaming window, wherein these windows are adapted to play the video-karaoke session, and wherein each of these windows has a playback start, stop and pause buttons.

15. Video-karaoke system according to claim 5, wherein it has a separate start, pause and stop button cluster adapted to control simultaneous playback of the music score, the video background and the user performance stream.

16. Video-karaoke system according to claim 14, wherein the video track streaming window has additional full screen and minimize buttons adapted to adjust the video streaming window size.

17. Video-karaoke system according to claim 14, wherein the audio track streaming window has additional volume up and down buttons.

18. Video-karaoke system according to claim 1, wherein its comprises record tool adapted to record the video-karaoke session on at least one server, and wherein its comprises do-not-record tool adapted to discard the video-karaoke session.

19. Video-karaoke system according to claim 8, wherein the autonomous video-karaoke generation mode is adapted to memorize the video-karaoke session as a user resource on at least one server.

20. Video-karaoke system according to claim 8, wherein the online performance mode is adapted to broadcast the performance through the network following selection of the music score.
